(19) United States
(12) Patent Application Publication
(10) Pub. No.: US 2018/0123999 A1
(43) Pub. Date: May 3, 2018

(54) TRACKING CLIENT LOCATION USING BUCKETS

(71) Applicant: International Business Machines Corporation, Armonk, NY (US)

(72) Inventors: Avshalom Houri, Netivot (IL); Uri Segev, Savyon (IL)

(21) Appl. No.: 15/336,608

(22) Filed: Oct. 27, 2016

(51) Int. Cl. H04L 12/58

(52) U.S. Cl. CPC H04L 51/20; H04L 67/42; H04L 51/04

(57) ABSTRACT

An example system includes a processor to receive a client location request from a first client and forward the client location request to a remote server including a bucket associated with requested second client. The processor is to also receive the requested client location from the remote server. The processor is to forward the requested client location to the first client. The requested client location is an address of a server at which the second client is connected.

### BACKGROUND

Aspects of the disclosure relate generally to computer systems and to tracking the location of clients, and more specifically, to tracking the servers that clients are connected to, particularly in the instant messaging context.

### SUMMARY

According to an embodiment described herein, a system can include a processor to receive a client location request from a first client and forward the client location request to a remote server including a bucket associated with a second client based on a bucket location list. The processor can also further receive the requested client location from the remote server. The processor can also forward the requested client location to the first client, wherein the requested client location is an address of a server at which the second client is connected.

According to another embodiment described herein, a method can include receiving, via a processor, a client location request from a first client and forward the client location request to a remote server including a bucket associated with the requested client based on a bucket location list. The method can also further include receiving, via the processor, the requested client location from the remote server. The method can also include forwarding, via the processor, the requested client location to the first client.

According to another embodiment described herein, a computer program product for can include computer-readable storage medium having program code embodied therewith. The computer readable storage medium is not a transitory signal per se. The program code is executable by a processor to cause the processor to receive a client location request from a first client and forward the client location request to a remote server including a bucket associated with the requested client based on a bucket location list. The program code can also cause the processor to receive the requested client location from the remote server. The program code can also cause the processor to forward the requested client location to the first client. The program code can also cause the processor to receive a location update from a second client and forward the location update to a remote server associated with the second client.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an example system that can track client location using buckets;

FIG. 2 is a process flow diagram of an example process that can track client location using buckets;

FIG. 3 is a process flow diagram of an example method that can track client location using buckets;

FIG. 4 is a process flow diagram of an example method that can track client subscriptions using buckets;

FIG. 5 is a process flow diagram of an example method that can reallocate buckets between servers;

FIG. 6 is a block diagram of an example computing device that can track client location using buckets;

FIG. 7 is a block diagram of an example cloud computing environment according to embodiments described herein;

FIG. 8 is an example abstraction model layers according to embodiments described herein; and

FIG. 9 is an example tangible, non-transitory computer-readable medium that can track client location using buckets.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Instant Messaging systems may have cases where a server may want to know to which server a specific user or client is connected. For example, when one client wants to send a message to another client, the server may need to know on which server the other client is located so that it can forward the message to the right server. In another example, when one client wants to subscribe to the presence information of another client, the server may need to know which other server holds the presence information for the other client so that the server can forward the subscription request to that other server.

Currently, directories may be used to connect to all servers in the community and subscribes on the User Up and User Down events from all servers. Each time a user logs in or out, the server that holds the user will notify all directories in the community and this way they will have an accurate location for all users. When a server wants to find the location of a user, it will send a locate request to the local directory.

However, when the number of users, and thus servers, increases, the servers may become too busy sending and receiving the User Up and User Down events from all other servers. Such log-in and log-out operations may be performed in O(n) time, where n is the number of servers. In addition, the directories may maintain the location for all users in the community, which might be a very large number and may require lots of memory. For at least these reasons, the current techniques may thus not scale to very large numbers of servers.

According to embodiments of the present techniques a processor can receive a client location request from a first client and forward the client location request to a remote server including a bucket associated with the requested client based on a bucket location list. As used herein, a bucket may refer to an in-memory table that contains information associated with clients tied to the bucket. The information for each client can include location, presence, and privacy information, among other types of information. For example, the bucket location list may have a list of servers and the buckets that each server stores. In some examples, each bucket may hold information for one or more clients. The processor may receive the requested client location from the remote server. The processor may then forward the requested client location to the first client. In some examples, the processor may subscribe to a remote server associated with the second client based on the bucket location list. The processor may then receive presence or privacy updates for the second client from the remote server. In some examples, the processor may detect that a new server has been added, a previous server has been removed, or two partitions are being combined. The processor may then reassign buckets to the new server, reassign buckets from the removed server to other servers, or combine the two partitions based on reduced bucket movement. The processor may then update the bucket location list on all servers. Thus, the location information of clients may be updated without updating all servers, as the location information may be updated at the server storing the bucket associated with the client. The location information may then be requested from the server with the bucket. Thus, the techniques may enable the location, presence, and privacy of clients to be tracked using less resources.

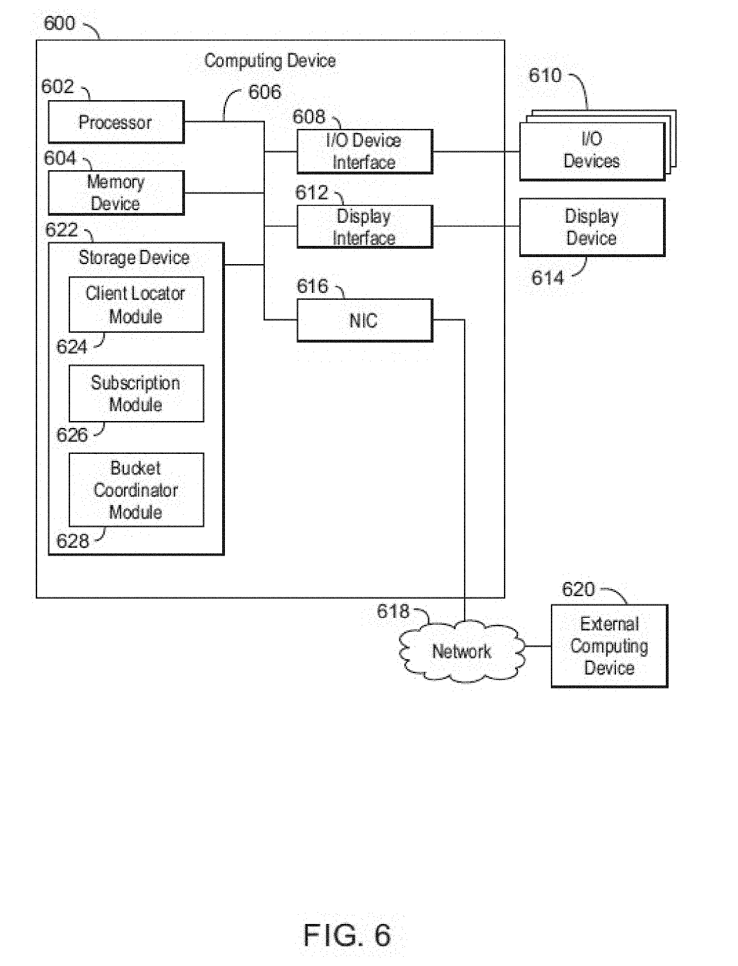

In some scenarios, the techniques described herein may be implemented in a cloud computing environment. As discussed in more detail below in reference to at least FIGS. 6, 7, and 8, a computing device configured to track client location using buckets may be implemented in a cloud computing environment. It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

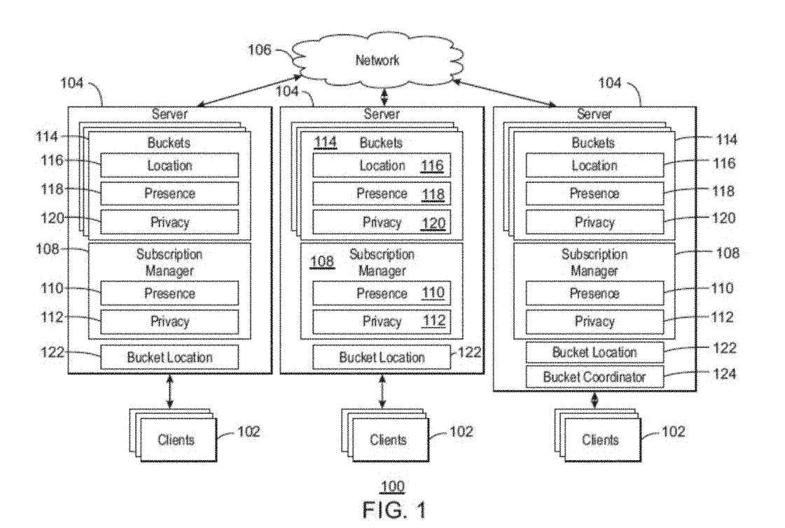

FIG. 1 is a block diagram of an example system that can track client location using buckets. The system is generally referred to using the reference number 100 and can be implemented at least in part using the computing device 600 of FIG. 6 below.

The example system 100 includes a number of clients 102 connected to a number of servers 104. For example, each client may be associated with a user. In some examples, each user may have a username and password to use to connect to a server 104. The system 100 may also include a network 106 to connect the servers 104. In some examples, the network may include cloud implementations as described below. The servers 104 include a subscription manager 108. The subscription manager may include presence information 110 and privacy information 112 for a number of users of local clients 102. The servers 104 may also include a number of buckets 114 including location information 116, presence information 118, and privacy information 120 for user accounts associated with the buckets 114. For example, the buckets 114 may include a hash table or hash map that may use a hash function to compute an index into an array of buckets from which a desired server location can be found. In some examples, each bucket may correspond to a user account with associated location information 116, presence information 118, and privacy information 120. In some examples, the buckets may be assigned clients using any suitable means of assignment. For example, the assignment may be a fixed form of assignment. The user IDs corresponding to clients may be hashed and divided by the total number of buckets in the system. Thus, the bucket that each user ID is assigned to may be calculated in advance. The servers 104 may also include bucket location information 122 including location information. For example, the location information may include a list of servers 104 and the buckets located at each server. In some examples, the buckets may be assigned to servers 104 using any suitable means of assignment. For example, one of the servers 104 may also include a bucket coordinator 124 to coordinate addition, removal, and reallocation of buckets 114 between servers. For example, the server 104 including the bucket coordinator 124 may be a master server.

In the example system 100, a number of clients 102 may be connected together via a network 106 of servers 104. For example, the clients 102 may include instant messaging software used to communicate across the network 106. In some examples, a first client 102 may want to know the location of a second client 102 in order to send a message to the second client 102. The first client 102 may send the message to a locally coupled server 104. The local server 104 may then check the bucket location information 122 to see if it has a bucket 114 associated with the second client 102. For example, each bucket 114 may have a list of clients 120 and corresponding location 106 for each client 102. In some examples, each bucket 114 may also have presence 118 and privacy 120 information for each client 102. Thus, if the local server 104 has a bucket 114 associated with the second client 102, then the local server 104 may use the location information 116 from the bucket 114 to send a message to the second client 102 at the location 116 specified in the bucket 114 associated with the second client 102.

In some examples, if the local server 104 does not include the bucket 114 associated with the second client 102, then the local server 104 may retrieve location information 116 from a remote server 104 that stores the bucket 114 associated with the second client 102 according to the bucket location information 122. For example, the remote server 104 may be connected to the local server 104 via the network 106. In some examples, each client may be associated with at least one bucket as described in greater detail below. Thus, the remote server 104 may provide the location information 116 to the local server 104, which may then use the location information 116 to send a message to a server 104 at which the second client 102 is connected. For example, the server 104 may be a second remote server 104 connected to the local server 104 and first remote server 104 via the network 106. The message may then be sent from the first client 102 connected to the local server 104 to the second client 102 connected to a second remote server 104. In some examples, the local server 104 may store the list of local clients 102 and may also forward Up/Down events from a client 102 to the remote server 104 maintaining the bucket 114 associated with the client 102. For example, Up events and Down events may indicate connections and disconnections, respectively, to the local server 104. In some examples, when a component requests the location of a client 102, the local server 104 may forward the request to the remote server 104, which may provide the location information 116, or maintain a subscription if needed. In some examples, the remote server 104 may then distribute the event to all interested servers 104, which may be a smaller number compared to all servers 104 in the community.

In some examples, each server 104 storing a particular bucket 114 may be responsible for maintaining information associated with clients that are assigned to that bucket 114. For example, the location information 116, presence information 118, and privacy information 120 for a subset of clients 102 may be maintained by the server 104 storing the bucket 114 associated with that subset of clients. Similarly, other servers 104 holding other buckets 114, may maintain information for clients 102 associated with those buckets 114. Thus, in addition to managing clients 102 that are logged in locally, each server 104 may also be responsible for managing the information of clients 102 associated with locally stored buckets 114.

In some examples, actual users' presence 118 and privacy 120 information may also be included in the buckets 114. For example, the local server 104 may maintain the information for the local clients 102, but may also forward the information to the remote servers maintaining the buckets 114 storing the presence 118 and privacy 120 information for the users. In some examples, each change in the presence information 118 may be forwarded by the local server 104 to the appropriate remote server, which may distribute the information to all interested subscription managers 108. The local subscription managers 108 may still maintain all the local subscriptions. However, the local subscription managers 108 may subscribe with the server 104 that maintains the user's bucket. Thus, each subscription manager 108 may subscribe directly with the remote server 104 that holds the user's bucket.

In some examples, the bucket coordinator 124 on a master server 104 may maintain the bucket location 122 information on the servers 104. For example, the bucket coordinator 124 may update the bucket location 122 on all servers 104 when a bucket is to be added, removed, or relocated between servers 104. All servers may always know which server 104 includes the bucket coordinator 124. In some examples, when a new server is added, the master server 104 may be notified and can reassign the buckets 114 as needed. In some examples, when a server 104 goes down, the master server 104 may similarly be notified and can reassign the buckets 114 as needed. In some examples, if the master server 104 goes down, another server 104 may become the master and continue where the last master server left off. In some examples, master server selection can be performed by having all servers 104 sort the list of servers and select the first server 104 in the list. In some examples, the master server 104 may distribute the bucket location list 122 to all other servers 104. Thus, the master server may minimize the amount of messages sent.

In some examples, when a bucket 114 is moved from one server to another, all servers 104 may be notified about the change. For example, depending on the selected option, either an online director (OLD) or a Presence Service Provider (PSP) may be used to provide the new servers 104 that hold the moved buckets 114 all the associated information. In some examples, the subscription manager 108 may also resend the subscriptions on all users that belong to buckets 114 that moved. Although bucket relocation may be somewhat intensive process, such bucket relocation may also be infrequent, occurring when the number of servers 104 changes in the environment.

In some examples, the servers 104 may be partitioned. For example, a network connection 106 between two sets of servers 104 may go down, with each partition detecting that all the servers 104 in the other partition are down. In some examples, such partitioning may cause both partitions to rearrange the buckets, causing each partition to have a complete and separate set of buckets 114. When the partitions are reconnected, each bucket 114 may exist twice, and the master server 104 may fix any duplication. For example, the master server 104 may perform bucket reallocation in a manner that will cause the least amount of bucket movement. In some examples, if the master server 104 fails, then another server 104 may initialize a bucket coordinator 124 to maintain the bucket location information 122.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional clients, buckets, servers, networks, etc.).

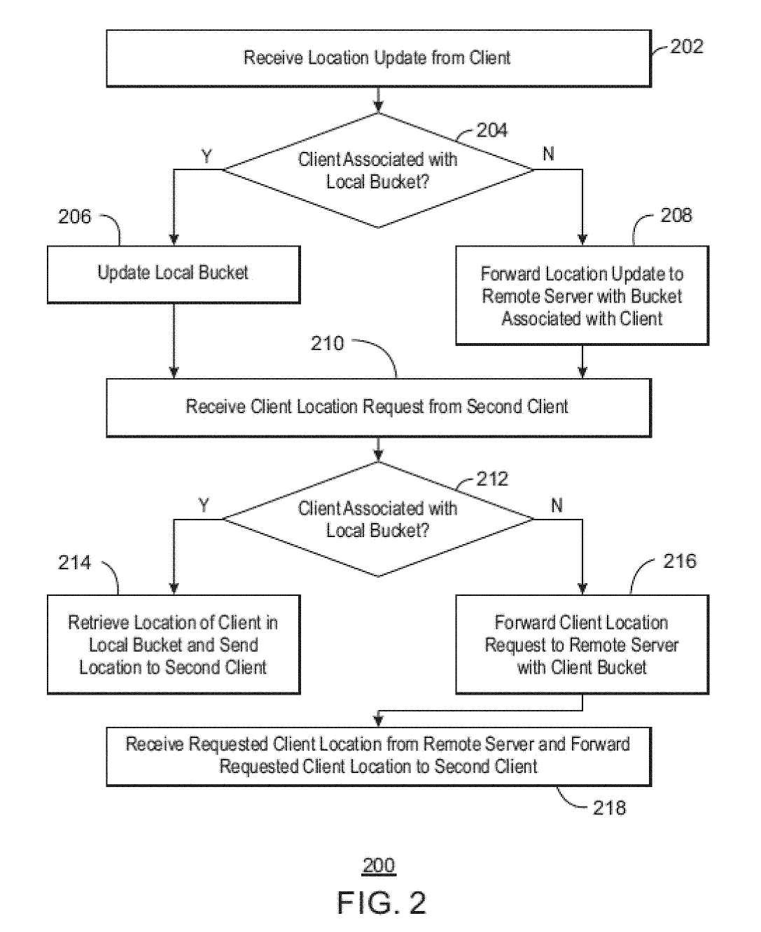

FIG. 2 is a process flow diagram of an example method that can track client location using buckets. The method 200 can be implemented with any suitable computing device, such as the computing device 600 of FIG. 6. For example, the method 200 can be implemented via the processor 602 of computing device 600.

At block 202, the processor receives a location update from a client. For example, the client may have connected to a new server and thus have a new client location. For example, the client location may be the address of the new server.

At diamond 204, the processor determines whether the client is associated with a local bucket. If the client is associated with a local bucket, then the method may proceed at block 206. If the client is not associated with a local bucket, then the method may proceed at block 208. In some examples, the processor may determine whether the client is associated with a local bucket using a bucket location list that includes all buckets and the servers they are located on. For example, the buckets and servers may have identification numbers or any suitable form of identification. In some examples, servers may be identified using media access control (MAC) addresses. In some examples, buckets may be provided unique identification numbers. In some examples, the buckets may have been assigned clients using any suitable means of assignment. In some examples, the assignment may be a fixed form of assignment. For example, the IDs corresponding to clients may be hashed and divided by the total number of buckets in the system

At block 206, the processor updates the local bucket if the client is associated with the local bucket. For example, the location of the client may be updated in the bucket associated with the client.

At block 208, the processor forwards the location update to a remote server with a bucket associated with the client if the client is not associated with the local bucket. For example, the location of the client may be updated in the bucket associated with the client on the remote server.

At block 210, the processor receives a client location request from a second client. For example, the second client may be sending a message to the first client and therefore may need to know the location of the server that the first client is connected to.

At diamond 212, the processor determines whether the client is associated with a local bucket. If the client is associated with a local bucket, then the method may proceed to block 214. If the client is not associated with a local bucket, then the method may proceed at block 216. For example, the processor may determine whether the client is associated with a local bucket by checking the bucket location list to see if the local server is associated with that bucket.

At block 214, the processor retrieves location of client from the local bucket and sends the location to the second client. For example, the location may be the name or address of a server that the second client is connected to.

At block 216, the processor forwards the client location request to a remote server with a bucket associated with the client. For example, the remote server may have been assigned to keep track of the client's location in the bucket associated with the client.

At block 218, the processor receives the requested client location from the remote server and forwards the requested client location to the second client. For example, the second client may receive a server name or server address corresponding to the server that the client is connected to. The second client may then be able to send messages or other information to the client.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

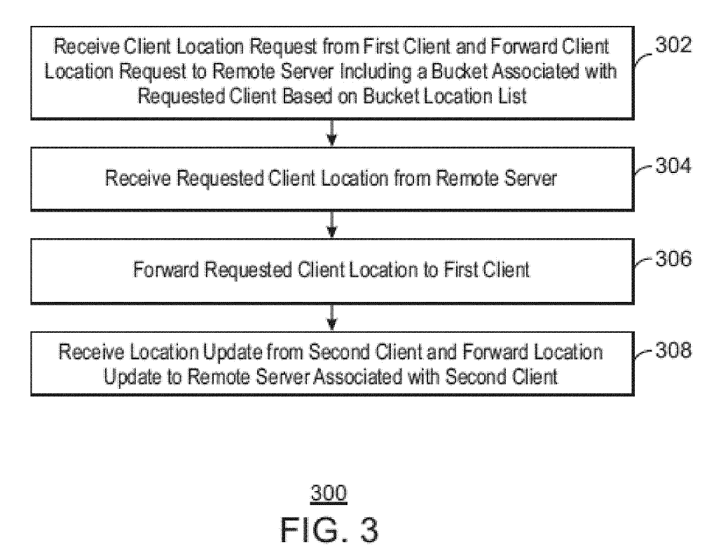

FIG. 3 is a process flow diagram of an example method that can track client location using buckets. The method 300 can be implemented with any suitable computing device, such as the computing device 600 of FIG. 6. For example, the method 300 can be implemented via the processor 602 of computing device 600.

At block 302, the processor receives a client location request from a first client and forwards the client location request to a remote server including a bucket associated with the requested client based on a bucket location list. For example, the bucket location list may include a list of servers and the buckets that each server stores.

At block 304, the processor receives the requested client location from the server. For example, the request client location may include the server name or server address of the server at which the client is connected.

At block 306, the processor forwards the requested client location to the first client. For example, first client may receive the name or address of the server at which the requested client is connected.

At block 308, the processor receives a location update from a second client and forward the location update to a server associated with the second client. For example, the second client may have connected to a new server and thus have a new location.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

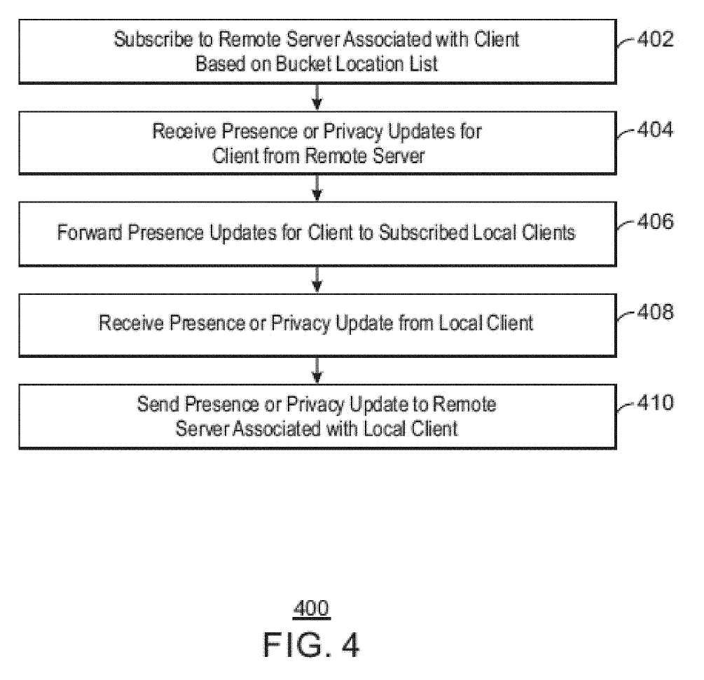

FIG. 4 is a process flow diagram of an example method that can track client subscriptions using buckets. The method 400 can be implemented with any suitable computing device, such as the computing device 600 of FIG. 6. For example, the method 400 can be implemented via the processor 602 of computing device 600.

At block 402, the processor subscribes to a remote server associated with a client based on the bucket location list. For example, the remote server may include a bucket including information associated with the client. In some examples, the processor may use a bucket location list to determine the location of the remote server including the bucket associated with the client.

At block 404, the processor receives presence or privacy updates for the client from the remote server. For example, presence updates may include a change to being active, away, in a meeting, among other presence statuses. In some examples, privacy updates may include changes to a list of users that are allowed to see the status of a user. For example, one or more users may be added or removed from the list of users that may receive presence updates.

At block 406, the processor forwards presence updates for the client to subscribed local clients. For example, the subscribed local clients may be updated that the client is online and available to receive messages. In some examples, the processor may forward the presence updates to the first client based on updated privacy information. For example, the processor may forward presence updates to clients in a list of clients that are both subscribed and allowed to receive the presence updates. Thus, the processor may first verify that the first client is on the list of clients to receive the presence updates for a particular user before sending a presence update to the subscribed client.

At block 408, the processor receives a presence or privacy update from a local client. For example, the local client may have connected to the server and thus be online and available for messaging. In some examples, the local client may have made changes to a list of other clients allowed to see presence updates.

At block 410, the processor sends the presence or privacy update to a remote server associated with the local client. For example, the remote server may contain a bucket associated with the local client and store the presence or privacy update in the bucket.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

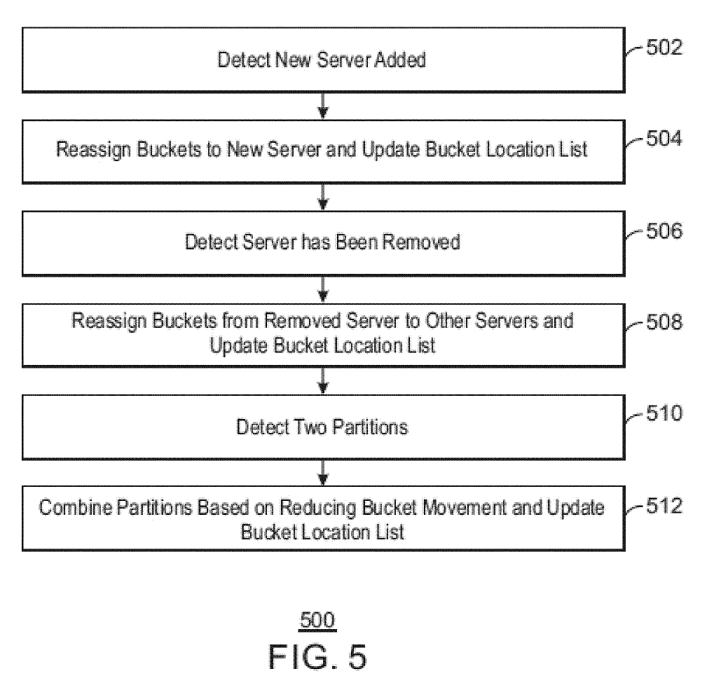

FIG. 5 is a process flow diagram of an example method that can reallocate buckets between servers. The method 500 can be implemented with any suitable computing device, such as the computing device 600 of FIG. 6. For example, the method 500 can be implemented via the processor 602 of computing device 600 or the bucket coordinator 124 of FIG. 1 above.

At block 502, the processor detects that a new server has been added. For example, a new server to store buckets may have been added to increase the capacity of the network.

At block 504, the processor reassigns buckets to the new server and updates the bucket location list. For example, the buckets may be evenly redistributed among the total number of servers.

At block 506, the processor detects that a server has been removed. For example, the removed server may have failed or may have been removed for maintenance.

At block 508, the processor reassigns buckets from the removed server to other servers and updates the bucket location list. For example, the processor may evenly redistribute the buckets that were previously assigned to the removed server among the rest of the servers.

At block 510, detects two or more partitions. For example, two previously separate networks may be joined together so that clients from the two or more partitions may communicate with each other.

At block 512, combines the two partitions based on reducing bucket movement and updates the bucket location list. For example, most of the previously assigned buckets may remain assigned to the same servers, while some buckets may be reassigned to other servers in order to balance server load.

The process flow diagram of FIG. 5 is not intended to indicate that the operations of the method 500 are to be executed in any particular order, or that all of the operations of the method 500 are to be included in every case. Additionally, the method 500 can include any suitable number of additional operations.

With reference now to FIG. 6, an example computing device can track client location using buckets. The computing device 600 may be for example, a server, desktop computer, laptop computer, tablet computer, or smartphone. In some examples, computing device 600 may be a cloud computing node. Computing device 600 may be described in the general context of computer system executable instructions, such as program modules, being executed by a computer system. Generally, program modules may include routines, programs, objects, components, logic, data structures, and so on that perform particular tasks or implement particular abstract data types. Computing device 600 may be practiced in distributed cloud computing environments where tasks are performed by remote processing devices that are linked through a communications network. In a distributed cloud computing environment, program modules may be located in both local and remote computer system storage media including memory storage devices.

The computing device 600 may include a processor 602 that is to execute stored instructions, a memory device 604 to provide temporary memory space for operations of said instructions during operation. The processor can be a single-core processor, multi-core processor, computing cluster, or any number of other configurations. The memory 604 can include random access memory (RAM), read only memory, flash memory, or any other suitable memory systems.

The processor 602 may be connected through a system interconnect 606 (e.g., PCI®, PCI-Express®, etc.) to an input/output (I/O) device interface 608 adapted to connect the computing device 600 to one or more I/O devices 610. The I/O devices 610 may include, for example, a keyboard and a pointing device, wherein the pointing device may include a touchpad or a touchscreen, among others. The I/O devices 610 may be built-in components of the computing device 600, or may be devices that are externally connected to the computing device 600.

The processor 602 may also be linked through the system interconnect 606 to a display interface 612 adapted to connect the computing device 600 to a display device 614. The display device 614 may include a display screen that is a built-in component of the computing device 600. The display device 614 may also include a computer monitor, television, or projector, among others, that is externally connected to the computing device 600. In addition, a network interface controller (NIC) 616 may be adapted to connect the computing device 600 through the system interconnect 606 to the network 618. In some embodiments, the NIC 616 can transmit data using any suitable interface or protocol, such as the internet small computer system interface, among others. The network 618 may be a cellular network, a radio network, a wide area network (WAN), a local area network (LAN), or the Internet, among others. An external computing device 620 may connect to the computing device 600 through the network 618. In some examples, external computing device 620 may be an external webserver 620. In some examples, external computing device 620 may be a cloud computing node.

The processor 602 may also be linked through the system interconnect 606 to a storage device 622 that can include a hard drive, an optical drive, a USB flash drive, an array of drives, or any combinations thereof. In some examples, the storage device may include a client locator module 624, a subscription module 626, and a bucket coordinator module 628. The client locator module 624 can receive a client location request from a first client and forward the client location request to a remote server including a bucket associated with the requested client based on a bucket location list. For example, the client location may be the address of the local server via which the client is connected to a network. The client locator module 624 can receive the requested client location from the remote server. The client locator module 624 can then forward the requested client location to the first client. In some examples, the client locator module 624 can receive a location update from a second client and forward the location update to a remote server associated with the second client. For example, the second client may have connected to a new server with a new address. The subscription module 626 can subscribe to a remote server associated with the second client based on the bucket location list. For example, the remote server may include a bucket that stores updated information for the second client. The subscription module 626 can receive presence and privacy updates for the second client from the remote server. The subscription module 626 can then forward presence updates for the second client to the first client based on the privacy updates. In some examples, the subscription module 626 can receive a presence or privacy update from a third client. The subscription module 626 can then send the presence or privacy update to a remote server associated with the third client. For example, the remote server may store a bucket associated with the third client.

In some examples, the bucket coordinator module 628 can detect that a new server has been added, reassign buckets to the new server, and update the bucket location list. In some examples, the bucket coordinator module 628 can detect that a server has been removed, reassign buckets from the removed server to other servers, and update the bucket location list. In some examples, the bucket coordinator module 628 can detect two partitions, combine the two partitions based on reducing bucket movement, and update the bucket location list.

It is to be understood that the block diagram of FIG. 6 is not intended to indicate that the computing device 600 is to include all of the components shown in FIG. 6. Rather, the computing device 600 can include fewer or additional components not illustrated in FIG. 6 (e.g., additional memory components, embedded controllers, modules, additional network interfaces, etc.). Furthermore, any of the functionalities of the client locator module 624, the subscription module 626, and the bucket coordinator module 628, may be partially, or entirely, implemented in hardware and/or in the processor 602. For example, the functionality may be implemented with an application specific integrated circuit, logic implemented in an embedded controller, or in logic implemented in the processor 602, among others. In some embodiments, the functionalities of the client locator module 624, the subscription module 626, and the bucket coordinator module 628 can be implemented with logic, wherein the logic, as referred to herein, can include any suitable hardware (e.g., a processor, among others), software (e.g., an application, among others), firmware, or any suitable combination of hardware, software, and firmware.

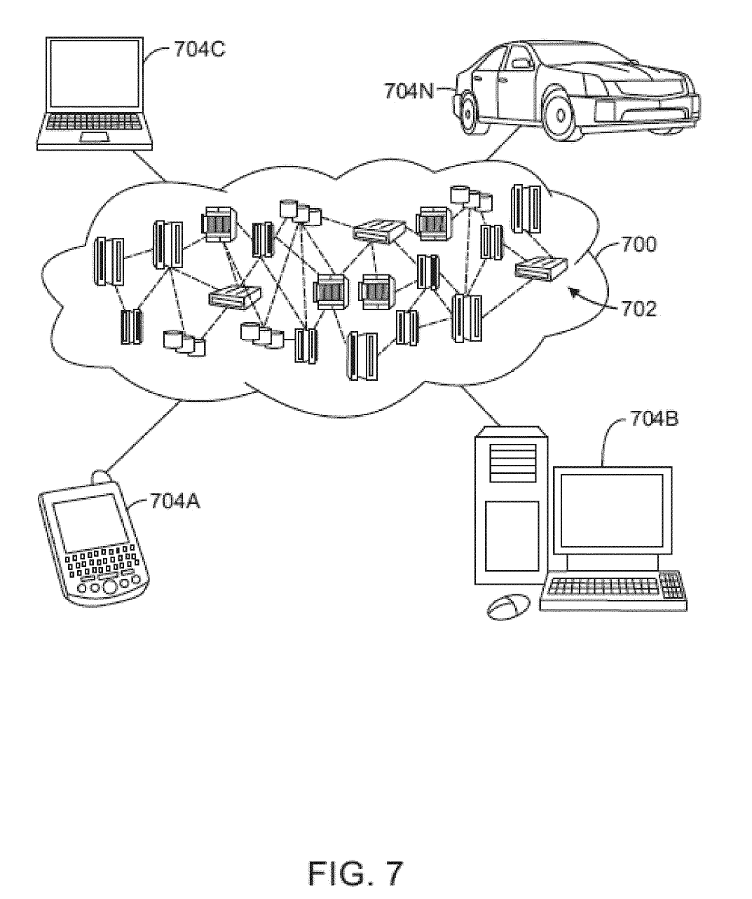

Referring now to FIG. 7, an illustrative cloud computing environment 700 is depicted. As shown, cloud computing environment 700 comprises one or more cloud computing nodes 702 with which local computing devices used by cloud consumers, such as, for example, personal digital assistant (PDA) or cellular telephone 704A, desktop computer 704B, laptop computer 704C, and/or automobile computer system 704N may communicate. Nodes 702 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 704A-N shown in FIG. 7 are intended to be illustrative only and that computing nodes 702 and cloud computing environment 700 can communicate with any type of computerized device over any type of network and/or network addressable connection (e.g., using a web browser).

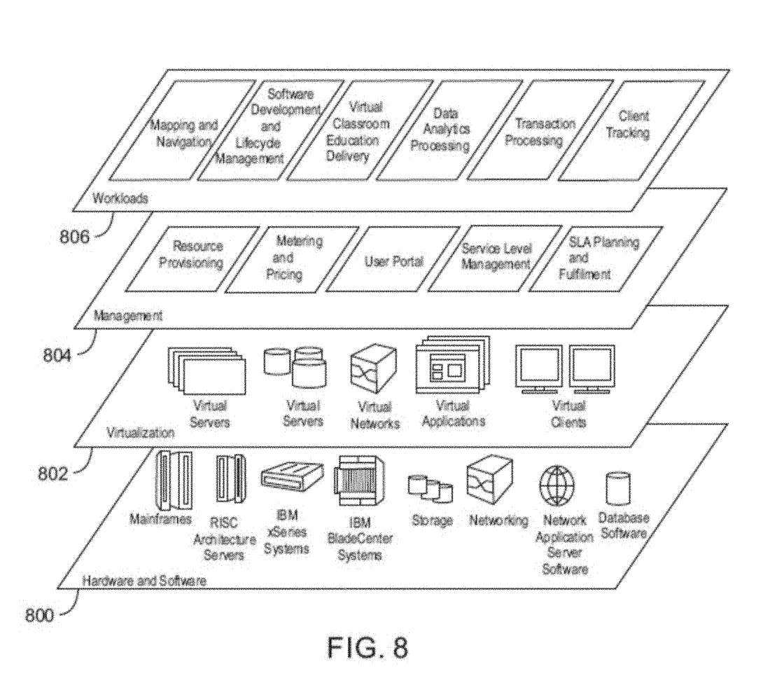

Referring now to FIG. 8, a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided.

Hardware and software layer 800 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM Web Sphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 802 provides an abstraction layer from which the following examples of virtual entities may be provided: virtual servers; virtual storage; virtual networks, including virtual private networks; virtual applications and operating systems; and virtual clients. In one example, management layer 804 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 806 provides examples of functionality for which the cloud computing environment may be utilized. Examples of workloads and functions which may be provided from this layer include: mapping and navigation; software development and lifecycle management; virtual classroom education delivery; data analytics processing; transaction processing; and client tracking.

The present techniques may be a system, a method or computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present techniques may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present techniques.

Aspects of the present techniques are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

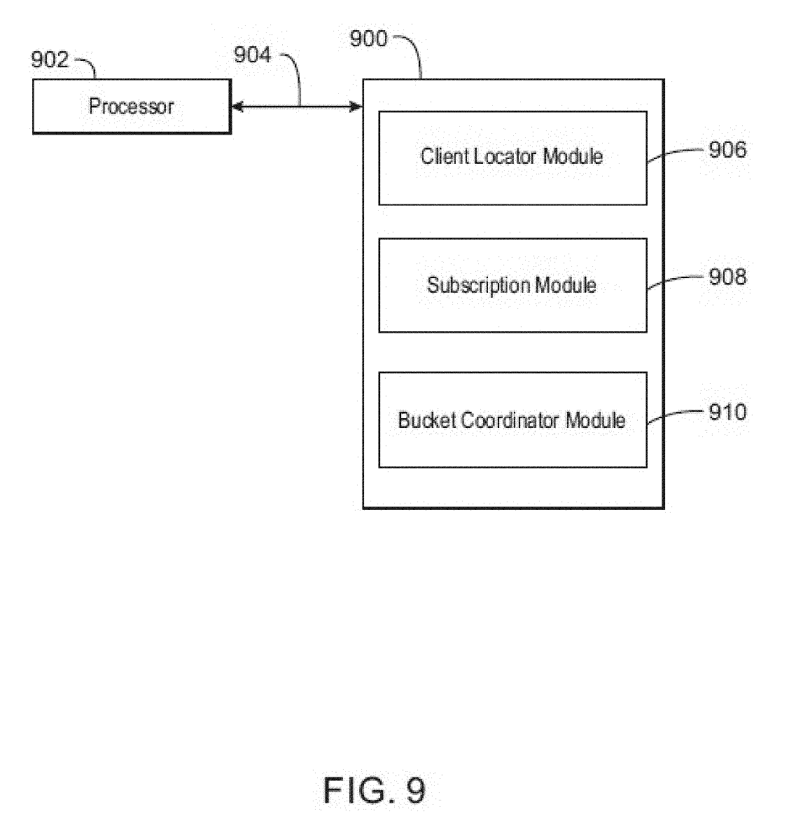

Referring now to FIG. 9, a block diagram is depicted of an example tangible, non-transitory computer-readable medium 900 that can track client location using buckets. The tangible, non-transitory, computer-readable medium 900 may be accessed by a processor 902 over a computer interconnect 904. Furthermore, the tangible, non-transitory, computer-readable medium 900 may include code to direct the processor 902 to perform the operations of the methods 300-500 of FIGS. 3-5 above.

The various software components discussed herein may be stored on the tangible, non-transitory, computer-readable medium 900, as indicated in FIG. 9. For example, a client locator module 906 includes code to receive a client location request from a first client and forward the client location request to a remote server including a bucket associated with the requested client based on a bucket location list. The client locator module 906 also includes code to receive the requested client location from the remote server. For example, the client location may be the address of the local server at which the client is connected. The client locator module 906 also includes code to forward the requested client location to the first client. The client locator module 906 includes code to receive a location update from a second client and forward the location update to a server associated with the second client. A subscription module 908 includes code to subscribe to a remote server associated with the second client based on the bucket location list. The subscription module 908 also includes code to receive a presence and privacy update for the second client from the remote server. The subscription 908 further includes code to forward the presence update for the second client to the first client based on the privacy update. In some examples, the subscription 910 may include code to receive presence or privacy update from a third client. In some examples, the subscription 908 may include code to send the presence or privacy update to a remote server associated with the third client. A bucket coordinator module 910 includes code to detect that a new server has been added, reassign buckets to the new server, and update the bucket location list. The coordinator module 910 may also include code to detect that a server has been removed, reassign buckets from the removed server to other servers, and update the bucket location list. The coordinator module 910 may also include code to detect two partitions, combine the two partitions based on reducing bucket movement, and update the bucket location list. It is to be understood that any number of additional software components not shown in FIG. 9 may be included within the tangible, non-transitory, computer-readable medium 900, depending on the particular application.

The flowchart and block diagrams in the Figures illustrate the architecture, functionality, and operation of possible implementations of systems, methods, and computer program products according to various embodiments of the present techniques. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A system, comprising a processor to:
receive a client location request from a first client and forward the client location request to a remote server comprising a bucket associated with a second client based on a bucket location list;
receive the requested client location from the remote server; and
forward the requested client location to the first client, wherein the requested client location is an address of a server at which the second client is connected.

2. The system of claim 1, wherein the processor is to receive a location update from a second client and forward the location update to a remote server associated with the second client.

3. The system of claim 1, wherein the processor is to:
subscribe to a remote server associated with a second client based on the bucket location list;
receive presence and privacy updates for the second client from the remote server; and
forward presence updates for the second client to the first client based on the privacy updates.

4. The system of claim 1, wherein the processor is to:
receive a presence or privacy update from a third client; and
send the presence or privacy update to a remote server associated with the third client.

5. The system of claim 1, wherein the processor is to detect that a new server has been added, reassign buckets to the new server, and update the bucket location list.

6. The system of claim 1, wherein the processor is to detect that a server has been removed, reassign buckets from the removed server to other servers, and update the bucket location list.

7. The system of claim 1, wherein the processor is to detect two partitions, combine the two partitions based on reducing bucket movement, and update the bucket location list.

8. A computer-implemented method, comprising:
receiving, via a processor, a client location request from a first client and forward the client location request to a remote server comprising a bucket associated with the requested client based on a bucket location list;
receiving, via the processor, the requested client location from the remote server; and
forwarding, via the processor, the requested client location to the first client.

9. The computer-implemented method of claim 8, comprising receiving, via a processor, a location update from a second client and forward the location update to a remote server associated with the second client.

10. The computer-implemented method of claim 8, comprising:
subscribing, via the processor, to a remote server associated with the second client based on the bucket location list;
receiving, via the processor, a presence and a privacy update for the second client from the remote server; and
forwarding, via the processor, the presence update for the second client to the first client based on the privacy update.

11. The computer-implemented method of claim 8, comprising:
receiving, via the processor, presence or privacy update from a third client; and
sending, via the processor, the presence or privacy update to a remote server associated with the third client.

12. The computer-implemented method of claim 8, comprising detecting, via the processor, that a new server has been added, reassigning buckets to the new server, and updating the bucket location list.

13. The computer-implemented method of claim 8, comprising detecting, via the processor, that a server has been removed, reassigning buckets from the removed server to other servers, and updating the bucket location list.

14. The computer-implemented method of claim 8, comprising detecting, via the processor, two partitions, combining the two partitions based on reducing bucket movement between servers, and updating the bucket location list.

15. A computer program product for tracking client location using buckets, the computer program product comprising a computer-readable storage medium having program code embodied therewith, wherein the computer readable storage medium is not a transitory signal per se, the program code executable by a processor to cause the processor to:
receive a client location request from a first client and forward the client location request to a remote server comprising a bucket associated with the requested client based on a bucket location list;
receive the requested client location from the remote server;
forward the requested client location to the first client; and
receive a location update from a second client and forward the location update to a remote server associated with the second client.

16. The computer program product of claim 15, comprising program code executable by the processor to:
subscribe to a remote server associated with the second client based on the bucket location list;
receive a presence update and a privacy update for the second client from the remote server; and
forward the presence update for the second client to the first client based on the privacy update.

17. The computer program product of claim 15, comprising program code executable by the processor to:
receive presence or privacy update from a third client; and
send the presence or privacy update to a remote server associated with the third client.

18. The computer program product of claim 15, comprising program code executable by the processor to detect that a new server has been added, reassign buckets to the new server, and update the bucket location list.

19. The computer program product of claim 15, comprising program code executable by the processor to detect that a server has been removed, reassign buckets from the removed server to other servers, and update the bucket location list.

20. The computer program product of claim 15, comprising program code executable by the processor to detect two partitions, combine the two partitions based on reducing bucket movement, and update the bucket location list.
